(19) United States
(12) Patent Application Publication
(10) Pub. No.: US 2020/0090442 A1
(43) Pub. Date: Mar. 19, 2020

(54) SHEET PROCESSING APPARATUS, SHEET PROCESSING SERVER, AND SHEET PROCESSING SYSTEM

(71) Applicant: GLORY LTD., Hyogo (JP)

(72) Inventors: Koichi NISHIDA, Hyogo (JP); Kouichi NABEYAMA, Hyogo (JP); Risa HORITA, Hyogo (JP)

(73) Assignee: GLORY LTD., Hyogo (JP)

(21) Appl. No.: 16/568,749

(22) Filed: Sep. 12, 2019

(30) Foreign Application Priority Data
Sep. 14, 2018 (JP) 2018-172204

(51) Int. Cl. G07D 11/50; G07D 11/18; G07D 11/23; G07D 11/34; G07D 11/60

(52) U.S. Cl. CPC G07D 11/50; G07D 11/18; G07D 11/23; B65H 2701/1912; G07D 11/60; G07D 2211/00; G07D 11/34

(57) ABSTRACT

To make it possible to omit advance preparation for processing a sheet using a header card at a cash collection center. A sheet processing apparatus includes: a recognition unit that recognizes a kind of a sheet; a transport unit that transports the recognized sheet; a storage unit that stores therein a sheet group consisting of the transported sheets; and a control unit. The sheets include a first sheet to which value is given, and a second sheet to which identification information for identifying the sheet group is given in advance. The control unit controls the transport unit based on a recognition result by the recognition unit such that the transport unit transports at least one of the sheets recognized as the first sheet to be received by the storage unit and at least one of the sheets recognized as the second sheet into the storage unit.

### CROSS REFERENCE TO RELATED APPLICATIONS

This application is entitled to (or claims) the benefit of Japanese Patent Application No. 2018-172204, filed on Sep. 14, 2018, the disclosure of which including the specification, drawings and abstract is incorporated herein by reference in its entirety.

### TECHNICAL FIELD

The present invention relates to a sheet processing apparatus, a sheet processing server, and a sheet processing system used for sheet processing.

### BACKGROUND ART

Conventionally, an operation to collect cash and transfer this cash to a base called a cash collection center to manage the cash is performed in a branch office of a bank, a large commercial establishment, and the like.

For example, depositing processing of banknotes collected from a plurality of stores in the commercial establishment is performed by a banknote processing apparatus installed in a back office in the commercial establishment after the end of business hours and before transferring of proceeds from sales for a day to the cash collection center. That is, the total money amount and the like of the banknotes collected from each of the stores are counted by the banknote processing apparatus for each of the stores.

The deposited banknotes are put together on a store-by-store basis and transferred to the cash collection center. In the cash collection center, the banknotes transferred from the commercial establishment are processed by a banknote processing apparatus, and the total money amount and the like of the collected banknotes are counted again for each of the stores. Then, as for this total money amount and the like, it is verified in the cash collection center whether the money amount of the banknotes and the number of sheets for each denomination of the banknotes deposited at each of the stores are the same as those counted again at the cash collection center.

In order that such processing at the cash collection center can be performed easily, various techniques has been proposed, in which the banknotes can be continuously processed while distinguished for each transaction by utilizing a header card with printed identification information such as a bar code and a serial number (e.g., see Patent Literature (hereinafter referred to as “PTL”) 1). For example, the depositing processing, in which depositing of banknotes that are collected for each day from each of the stores belonging to this commercial establishment is treated as one transaction, is performed in the commercial establishment from which the banknotes are transferred. In the cash collection center to which the banknotes are transferred, the header card is stacked on top of the banknotes for each transaction, for which the depositing processing in the commercial establishment is finished, and the banknotes for a plurality of transactions are continuously processed by the sheet processing apparatus while distinguished between one transaction and another in accordance with header cards.

### CITATION LIST

### Patent Literature

### PTL 1

U.S. Pat. No. 5,917,930

### SUMMARY OF INVENTION

### Technical Problem

However, advance preparation for stacking the header card on top of the banknotes for each of the transactions at the cash collection center is necessary in the technique described above, and this advance preparation takes time and effort.

The present invention is invented to solve such a problem, and an object of the present invention is to make it possible to omit the advance preparation for processing sheets using the header cards at the cash collection center.

### Solution to Problem

To solve the aforementioned conventional problem, a sheet processing apparatus according to the present invention comprises: a recognition unit that recognizes a kind of a sheet; a transport unit that transports the sheet recognized by the recognition unit; a storage unit that stores therein a sheet group consisting of a plurality of the sheets transported by the transport unit; and a control unit. The plurality of sheets includes a first sheet to which value is given, and a second sheet to which identification information for identifying the sheet group is given in advance. The control unit controls the transport unit based on a recognition result by the recognition unit such that the transport unit transports at least one of the plurality of sheets recognized as the first sheet to be received by the storage unit and at least one of the plurality of sheets recognized as the second sheet into the storage unit.

### Advantageous Effects of Invention

According to the present invention, it is possible to omit advance preparation for processing sheets using header cards at a cash collection center.

### BRIEF DESCRIPTION OF DRAWINGS

FIG. 1 schematically illustrates an entire configuration of a sheet processing system common among embodiments of the present invention:

FIG. 2 schematically illustrates a configuration of a banknote processing apparatus of Embodiment 1 of the present invention:

FIG. 3 is a functional block diagram illustrating a configuration of a control system of the banknote processing apparatus of Embodiment 1 of the present invention:

FIG. 4 is a flowchart illustrating an exemplary control flow of banknote processing according to Embodiment 1 of the present invention:

FIG. 5 schematically illustrates a configuration of a banknote processing apparatus of Embodiment 2 of the present invention;

FIG. 6 is a flowchart illustrating an exemplary control flow of banknote processing according to Embodiment 2 of the present invention:

FIG. 7 schematically illustrates a configuration of a banknote processing apparatus of Embodiment 3 of the present invention; and

FIG. 8 schematically illustrates a configuration of a banknote processing apparatus of Embodiment 4 of the present invention.

### DESCRIPTION OF EMBODIMENTS

Hereinafter, a sheet processing apparatus according to embodiments of the present invention will be described with reference to the accompanying drawings. The respective embodiments described below are only illustrations, and do not exclude various modifications and applications of techniques which are not specified in the following embodiments. Moreover, components of the embodiments may be implemented while variously modified without departing from the spirit and scope of each of these embodiments. Further, each of the components of the embodiments may be selected as needed, or combined appropriately.

In the following, a description will be given of a case where a banknote is used as a “first sheet to which value is given” of the present invention. In addition to the banknote, the “first sheet to which value is given” includes securities, such as a note, a check, a stock certificate, and a voucher.

Additionally, a “rejected sheet” as used in this specification refers to a sheet which cannot be a processing target for predetermined processing. Examples of the rejected sheet include: a counterfeit note; a banknote and a below-described card which are passed through a below-mentioned recognition unit obliquely or overlappingly and therefore cannot be correctly recognized by the recognition unit. A “fit note” means a banknote which is comparatively little stained, tom, and the like.

Note that, the same elements in the figures are provided with the same reference symbols among all the figures for explaining the embodiments, and their descriptions may be omitted.

### 1. Entire Configuration of Sheet Processing System According to Embodiments

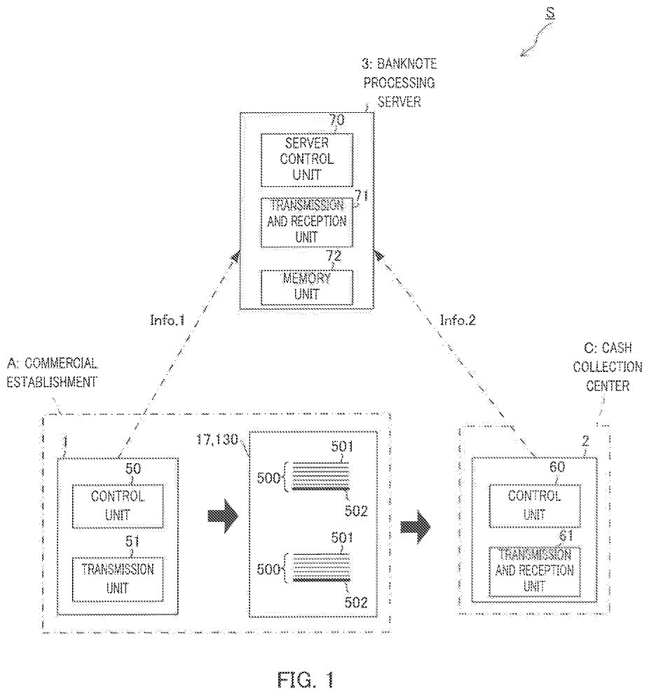

An entire configuration of a sheet processing system common among the embodiments of the present invention will be described with reference to FIG. 1. FIG. 1 schematically illustrates the entire configuration of the sheet processing system common among the embodiments of the present invention.

As illustrated in FIG. 1, a banknote processing system S (sheet processing system) comprises a banknote processing apparatus 1 (first processing apparatus), a banknote processing apparatus 2 (second processing apparatus), and a banknote processing server 3 (sheet processing server). The banknote processing apparatus 1 is installed in a back office of a commercial establishment A including a plurality of stores in the present embodiment. The banknote processing apparatus 2 is installed in a cash collection center C.

The banknote processing apparatus 1 comprises a control unit 50 and a transmission unit 51, and, as for proceeds from sales of each of the stores in the commercial establishment A, performs processing to obtain, as money amount information (sheet group information), at least a sales proceeds amount from among the sales proceeds amount and the number of sheets of banknotes for each denomination by counting the banknotes of the proceeds from sales for each of the stores. Hereinafter, this processing, that is, processing to obtain at least the sales proceeds amount from among the sales proceeds amount and the number of sheets of the banknotes for each denomination, is referred to as depositing processing in the embodiments.

This depositing processing is performed for each transaction of one day. That is, the sales proceeds amount for each of the stores in the commercial establishment A is obtained every day. The banknote processing apparatus 1 performs processing, which will be described in detail below, on a sheet group 500 corresponding to each of the transactions when performing the processing for each of the transactions of one day of each of the stores. Each of the sheet groups 500 consists of a plurality of banknotes 501 (first sheets) that are the proceeds from sales for one day of each of the stores and a card 502 (second sheet) that functions as a separator as described below. The banknote processing apparatus 1 stores the sheet groups 500.

The banknote processing apparatus 1 obtains the sheet group information for each of the sheet groups 500 when processing the sheet groups 500. The sheet group information is information on each of the sheet groups 500 and the banknotes 501 constituting the sheet group 500. In the present embodiment, the sheet group information includes store information on a store and date information on a date of the proceeds from sales in addition to the sales proceeds amount described above.

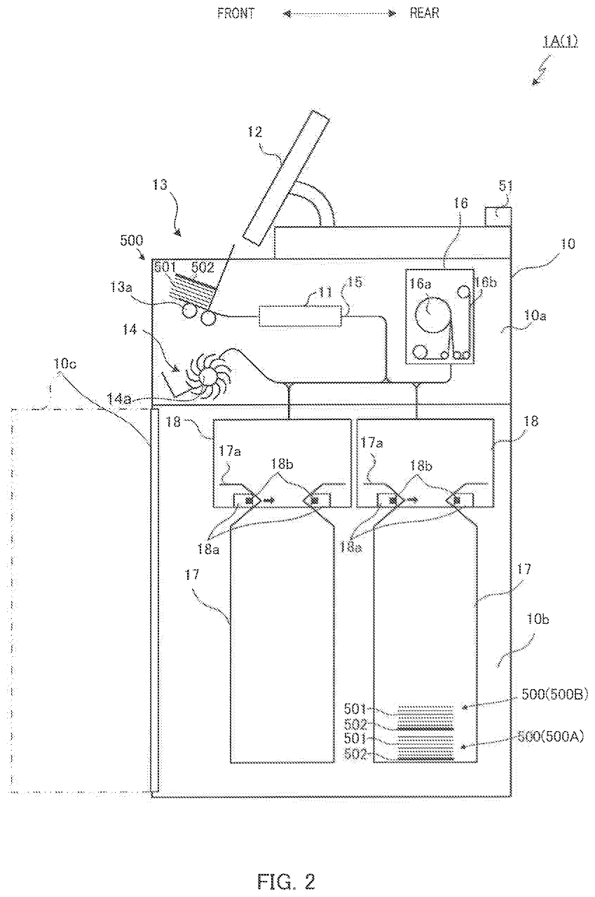

The control unit 50 can obtain the store information by input of the store information (e.g., an ID set for each of the stores) by an operator from a below-mentioned operation displaying unit 12 (see FIG. 2).

The control unit 50 can obtain the date information by input of the date information by the operator from the operation displaying unit 12 or can obtain the date information from a clock function that the control unit 50 itself has.

The sheet group information may also include operator information on operators who processed respective sheet groups 500. In this case, the control unit 50 can obtain the operator information by input of the operator information (e.g., an ID set for each of the operators) by each of the operators from the below-mentioned operation displaying unit 12 (see FIG. 2).

Hereinafter, the banknotes 501 and the card 502 are referred to as “sheets 501 and 502” when the banknotes 501 and the card 502 are not distinguished from each other.

The card 502 is a sheet to which information (identification information) for identifying one of the sheet groups 500 to which the card 502 belongs is given, and which is not a banknote. The identification information in the form of a serial number is given to the card 502 in the present embodiment. This serial number is different for each card 502. That is, the serial numbers indicated on the cards 502 are unique numbers. The serial numbers in a predetermined range (e.g., from 0001 to 1000) are assigned in advance to the commercial establishment A (users) in the present embodiment.

The banknote processing apparatus 1 transmits, via the transmission unit 51 to the banknote processing server 3, an information set Info.1 in which the sheet group information such as the sales proceeds amounts dependent on the banknotes 501 constituting the sheet groups 500 is associated with the serial numbers of the cards 502 corresponding respectively to the sheet groups 500.

The banknote processing apparatus 2 comprises a control unit 60 and a transmission and reception unit 61, and processes the sheet groups 500 for which the processing by the banknote processing apparatus 1 is finished and which are stored in a below-mentioned banknote storage bag 17 or storage cassette 130 and transported to the cash collection center C. Specifically, the banknote processing apparatus 2 obtains the total money amounts of the banknotes 501 of the sheet groups 500, that is, the sales proceeds amounts of the commercial establishment A, based on a recognition result of a recognition unit (not illustrated), and obtains the serial numbers of the cards 502 of the sheet groups 500 by the recognition unit. Then, the banknote processing apparatus 2 transmits, via the transmission and reception unit 61 to the banknote processing server 3, an information set Info.2 in which these pieces of information are associated with each other. Note that, when the sheet groups 500 are stored in the transparent banknote storage bag 17, the serial numbers of the sheet groups 500 can be read by a reader that is separate from the banknote processing apparatus 2 while the sheet groups 500 are stored in the transparent banknote storage bag 17. In this case, the information on the serial numbers is transmitted to the banknote processing apparatus 2 from the reader.

The banknote processing server 3 comprises a server control unit 70, a transmission and reception unit 71, and a memory unit 72 and compares the information set Info.1 obtained from the banknote processing apparatus 1 with the information set Info.2 obtained from the banknote processing apparatus 2. The transmission and reception unit 71 is an input unit in which the information set Info.1 output from the banknote processing apparatus 1 and the information set Info.2 output from the banknote processing apparatus 2 are input. Specifically, among the information sets Info. and Info.2 obtained from the banknote processing apparatuses 1 and 2, the banknote processing server 3 compares the sales proceeds amount included in the information set Info.1 with the sales proceeds amount included in the information set Info.2 sharing common serial numbers of the cards 502 with the information set Info.1. That is, the banknote processing server 3 verifies whether or not the sales proceeds amounts in the information sets Info.1 and Info.2 associated with each other by the serial numbers of the cards 502 and related to the same transactions are identical between the information sets Info.1 and Info.2. A result of this verification is indicated to the operator by an external output apparatus (not illustrated) attached to the banknote processing server 3.

As described above, the cards 502 having the serial numbers in the predetermined range are assigned to the commercial establishment A in advance, and each of these cards 502 functions as a separator. The memory unit 72 of the banknote processing server 3 contains therein correspondence between information (user information) for identifying a user of the banknote processing apparatus 1 and the serial number of each of the cards 502 (the correspondence is registered in advance). The banknote processing server 3 can identify the users of the banknote processing apparatus 1, that is, holders of the banknotes 501 of the sheet groups 500, from the serial number in accordance with the correspondence. The banknote processing server 3 associates the information set with this user information on the user of the banknote processing apparatus 1 and includes this user information in the information set, and outputs the information set to the banknote processing apparatus 2 in the cash collection center C.

Note that, instead that the serial numbers in the predetermined range (e.g., from 0001 to 1000) are assigned in advance (registered in advance) to the commercial establishment A, the holders of the banknotes 501 of the sheet groups 500 may be identified as follows.

That is, the banknote processing apparatus 1 may also be configured to include information for identifying this banknote processing apparatus 1 (hereinafter, such information is referred to as “apparatus information”) in the information set Info.1, and transmit the information set Info.1 to the banknote processing server 3. That is, the sales proceeds amounts of the commercial establishment A, the serial numbers of the cards 502, and the apparatus information may be associated with one another as the information set Info.1 and transmitted to the banknote processing server 3. Apparatus identification information given to the banknote processing apparatus 1 (for example, an apparatus-specific symbol) is used as the apparatus information.

In this case, correspondence between the information (user information) for identifying the users of the banknote processing apparatus 1 and the apparatus information is stored in the memory unit 72 of the banknote processing server 3. The banknote processing server 3 can identify, from the apparatus information in accordance with the correspondence, the users of the banknote processing apparatus 1, that is, the holders of the banknotes 501 of the sheet groups 500, and the banknote processing server 3 includes this user information in the information set, and transmits the information set to the banknote processing apparatus 2 in the cash collection center C.

Note that, verification of whether or not the sales proceeds amounts in the information sets Info.1 and Info.2 associated with each other by the serial numbers of the cards 502 and related to the same transactions are identical to each other may also be performed by the banknote processing apparatus 2 instead of the banknote processing server 3. In this case, the banknote processing apparatus 2 receives the information set Info.1 of the banknote processing apparatus 1 from the banknote processing apparatus 1 via the banknote processing server 3 or directly from the banknote processing apparatus 1.

### 2. Embodiment 1

[2-1. Configuration]

[2-1-1. Configuration of Banknote Processing Apparatus]

A description will be given of the banknote processing apparatus 1 of Embodiment 1 of the present invention with reference to FIG. 2. FIG. 2 schematically illustrates a configuration of the banknote processing apparatus of Embodiment 1 of the present invention.

The banknote processing apparatus 1 of the present embodiment is comprised of a banknote processing apparatus 1A illustrated in FIG. 2. This banknote processing apparatus 1A is configured to be capable of performing various processes such as a banknote depositing process. In the following description, the side of the banknote processing apparatus 1A on which the operation displaying unit 12 is disposed is referred to as “front” and the opposite side is referred to as “rear.” Additionally, the horizontal direction that is orthogonal to the front-rear direction is referred to as “left-right direction.”

As illustrated in FIG. 2, the banknote processing apparatus 1A comprises a housing 10 having a substantially rectangular parallelepiped shape. The transmission unit 51 described above is provided on the outside of the housing 10. The transmission unit 51 may also be provided inside the housing 10. An upper unit 10a and a lower unit 10b are housed inside the housing 10 so as to be able to be drawn forward from the front surface of the housing 10 respectively. An inlet unit 13, such as a receiving hopper, for putting the banknotes inside the housing 10 from the outside of the housing 10 is provided in an upper portion of the front surface of the housing 10 of the upper unit 10. Additionally, an outlet unit 14 for putting the banknotes outside the housing 10 from the inside of the housing 10 is provided below the inlet unit 13.

One sheet group 500 is set in the inlet unit 13 by the operator. The inlet unit 13 is provided with a banknote feeding mechanism 13a for feeding the sheets 501 and 502 constituting this sheet group 500 to the inside of the housing 10 one by one. Additionally, in the upper unit 10a, a transport unit 15 that transports the sheets 501 and 502 one by one in the housing 10 is provided inside the housing 10 of the banknote processing apparatus 1A, so that the banknotes fed from the inlet unit 13 by the banknote feeding mechanism 13a are transported one by one by the transport unit 15. Additionally, the recognition unit 11 is provided in the vicinity of the transport unit 15. The recognition unit 11 recognizes the denomination, authenticity, face/back, fitness, new/old, transport state, and the like of each of the banknotes 501 transported by the transport unit 15. Further, the recognition unit 11 recognizes that each of the cards 502 transported by the transport unit 15 is a card that functions as the separator, and also recognizes the serial number of the card 502. Note that, the recognition unit 11 may recognize the authenticity of the card 502.

As illustrated in FIG. 2, the transport unit 15 is connected to the outlet unit 14, and the sheets 501 and 502 sent to the outlet unit 14 from the transport unit 15 are stacked up in the outlet unit 14. In addition, the outlet unit 14 is accessible from the outside of the housing 10, and the operator can take out the sheets 501 and 502 stacked up in the outlet unit 14 from the front face of the housing 10. In addition, a portion of the transport unit 15 connected to the outlet unit 14 is provided with a stacking wheel 14a. This stacking wheel 14a is rotated, so that each of the sheets 501 and 502 put between two vanes of the stacking wheel 14a is stacked up in the outlet unit 14.

In addition, in the upper unit 10a, the transport unit 15 is provided with a storing/feeding unit 16 (temporary storage unit). The storing/feeding unit 16 stores the sheets 501 and 502 transported from the transport unit 15 and feeds the stored sheets 501 and 502 one by one to the transport unit 15. Thus, the banknotes stored in the storing/feeding unit 16 can be transported from the storing/feeding unit 16 to the banknote storage bag 17 (storage unit). Moreover, the banknotes stored in the storing/feeding unit 16 can also be transported from the storing/feeding unit 16 to the outlet unit 14, so that it is possible to easily deal with cancellation of depositing.

The storing/feeding unit 16 is a feeding apparatus of a tape-reel type. Specifically, the storing/feeding unit 16 is provided with a drum 16a that is rotatable in both of the forward and reverse directions, and one ends of a pair of beltlike tapes 16b are connected to the outer peripheral surface of the drum 16a. In addition, when the sheets 501 and 502 are sent to the storing/feeding unit 16 from the transport unit 15, the sheets 501 and 502 are caught up on the drum 16a individually by these beltlike tapes 16b wound around the drum 16a. Meanwhile, the reverse rotation of the drum 16a causes the tapes 16b to be unwound from the drum 16a, so that the sheets 501 and 502 caught up on the drum 16a are released out from the tapes 16b and fed to the transport unit 15.

As illustrated in FIG. 2, the lower unit 10b is provided with a plurality of banknote storage mechanisms 18 (two banknote storage mechanisms 18 in the present embodiment) for storing the sheet groups 500 inside banknote storage bags 17, such as pouch bags, in each of which an opening 17a is formed on its one side. Each of the banknote storage mechanisms 18 is provided with a pair of holding members 18a spaced apart from each other to be opposite each other. The holding members 18a respectively hold two portions of the banknote storage bag 17 located opposite each other in the vicinity of the opening of the banknote storage bag 17.

The banknote storage bag 17 is formed from a soft synthetic resin. The banknote storage bag 17 is entirely configured to be opaque, but may also be entirely configured to be semi-transparent or transparent. In addition, a part of the banknote storage bag 17 may be configured to be transparent or semi-transparent, while the remaining part may be configured to be opaque. The banknote storage bag 17 used in the present embodiment is of a stacking type in which the sheets 501 and 502 are stacked up from the bottom of the banknote storage bag 17 in the order in which the sheets 501 and 502 are stacked up in the banknote storage bag 17.

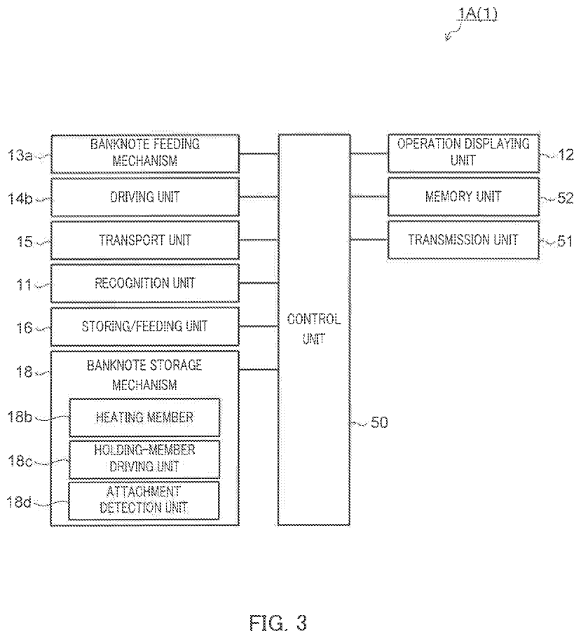

Here, the position of one of the holding members 18a (the one of the holding members 18a on the rear side in the present embodiment) is fixed. On the other hand, as illustrated by black solid arrows, the other one of the holding members 18a (the one of the holding members 18a on the front side in the present embodiment) is movable by a holding-member driving unit 18c (see FIG. 3) toward the holding member 18a on the rear side whose position is fixed. As illustrated in FIG. 2, the holding members 18a are provided with heating members 18b, respectively. In addition, after a predetermined number of sheet groups 500 are stored in the banknote storage bag 17 held by the holding members 18a in the banknote storage mechanism 18 and before the banknote storage bag 17 is taken out from the banknote storage mechanism 18, the front one of the holding members 18a moves toward the rear one of the holding members 18a. Then, the opening 17a of the banknote storage bag 17 is heat sealed (thermally sealed) by heating a portion of the banknote storage bag 17 located in the vicinity of the opening by the heating members 18b in a state where these holding members 18a are joined to each other.

The housing 10 is provided, at a lower part of the front surface of the housing 10, with a door 10c that is opened when the lower unit 10b is drawn from the inside to the outside of the housing 10. The banknote processing apparatus 1A is also provided with a door locking unit (not illustrated) that locks the door 10c in a closed state. Only those who have predetermined authority can unlock and open the door 10c locked by the door locking unit. Note that, the control unit 50 (see FIG. 1) can prohibit unlocking of the door 10c.

When collecting, from the banknote processing apparatus 1A, the banknote storage bags 17 in which the sheet groups 500 are stored and which are heat sealed by the heating members 18b at the openings 17a, an operator first unlocks and open the door 10c locked by the door locking unit as indicated by the two-dot chain line of FIG. 2. Then, after the lower unit 10b is drawn forward from the front face of the housing 10, it becomes possible for the operator to detach the banknote storage bags 17 from the holding members 18a of the banknote storage mechanisms 18 and collect them from the lower unit 10b.

The aforementioned operation displaying unit 12 is attached to the housing 10 on the upper front side. The operation displaying unit 12 is, for example, a touch panel. The operation displaying unit 12 displays information related to process statuses of various processes such as a banknote depositing process of the banknote processing apparatus 1A, an inventory amount of the banknotes stored in the banknote storage bags 17, and the like. In addition, the operator can give various instructions to the control unit 50 (see FIG. 3) by operating the operation displaying unit 12.

[2-1-2. Control Configuration]

As described above, the banknote processing apparatus 1A is provided with the control unit 50. A description will be given of this control unit 50 with reference to FIG. 3. FIG. 3 is a functional block diagram illustrating a configuration of a control system of the banknote processing apparatus 1A of Embodiment 1 of the present invention.

The control unit 50 is communicably connected to the banknote feeding mechanism 13a provided in the inlet unit 13, a driving unit 14b (not illustrated in FIG. 2) for driving the stacking wheel 14a provided in the outlet unit 14, the transport unit 15, the recognition unit 11, and the storing/feeding unit 16. The control unit 50 is also communicably connected to the banknote storage mechanisms 18.

Each of the banknote storage mechanisms 18 comprises the heating members 18b, the holding-member driving unit 18c that drives one of a pair of holding members 18a, and an attachment detection unit 18d that detects attachment of the banknote storage bag 17 to the holding members 18a. Illustrations of the holding-member driving unit 18c and the attachment detection unit 18d are omitted in FIG. 2.

The recognition result by the recognition unit 11, in particular, recognition information such as denominations of the banknotes 501 and 502 and the serial numbers (identification information) of the cards 502 is transmitted to the control unit 50. The control unit 50 controls the units constituting the banknote processing apparatus 1A on the basis of these pieces of information.

The operation displaying unit 12, the memory unit 52, and the transmission unit 51 are also connected to the control unit 50.

The memory unit 52 stores therein the information set Info.1 in which the sheet group information including the total money amount of the banknotes 501, the store information, and the date information is associated with the serial number of the card 502 for each of the sheet groups 500. The memory unit 52 further stores therein the information related to the number of sheets N1 of the sheets 501 and 502 for each of the sheet groups 500, and the number of sheets N2, the denomination, the serial number, the inventory amount, and the like of the banknotes 501 stored in each of the banknote storage bags 17. The memory unit 52 obtains these pieces of information from the recognition unit 11 via the control unit 50. The control unit 50 appropriately refers to the information stored in the memory unit 52 to use the information for controlling the banknote processing apparatus 1A.

In addition, the control unit 50 controls the transmission unit 51 such that the information set Info.1 for each of the sheet groups 500 stored in the memory unit 52 is transmitted to the banknote processing apparatus 2 in the cash collection center C (see FIG. 1).

Here, a description will be given of a function of the control unit 50 for performing the depositing processing on the sheet groups 500 to store them in the banknote storage bags 17.

When the control unit 50 detects receipt of operation by the operation displaying unit 12 to start the depositing processing, the control unit 50 controls the banknote feeding mechanism 13a such that the sheets 501 and 502 which are placed in the inlet unit 13 and constitute a sheet group 502 are fed to the transport unit 15 one by one in the order from the bottom sheet. In the example illustrated in FIG. 2, the card 502 placed on the top of the sheets 501 and 502 constituting the sheet group 500 is lastly fed to the transport unit 15.

The control unit 50 performs processing of controlling the transport unit 15 such that the sheets (banknotes 501) recognized by the recognition unit 11 as a sheet to be stored in the banknote storage bags 17 and the sheet (card 502) recognized by the recognition unit 11 as a card are transported to the storing/feeding unit 16. The storing/feeding unit 16 stores therein these sheets 501 and 502. Meanwhile, the control unit 50 controls the transport unit 15 such that the sheets 501 and 502 recognized by the recognition unit 11 to be the rejected sheets are transported to the outlet unit 14.

After all the sheets 501 and 502 constituting the sheet groups 500 are transported to the storing/feeding unit 16, the control unit 50 performs the following control when the control unit 50 detects receipt of the operation by the operation displaying unit 12 to store the sheet groups 500 to the banknote storage bags 17 (hereinafter, such operation is referred to as “storing operation”).

That is, the control unit 50 feeds, in the order reverse to the order in which the banknotes 501 and the cards 502 are stored, the banknotes 501 and the cards 502 stored in the storing/feeding unit 16 to supply them to the banknote storage bags 17. The example illustrated in FIG. 2 shows a state where two sheet groups 500 are already stored in one of the banknote storage bags 17 while stacked on one another. Specifically, FIG. 2 shows the state where a lower sheet group 500A (second sheet group) and an upper sheet group 500B (first sheet group) are stored in the banknote storage bag 17 with their cards 502 being at their bottoms (at their lowermost positions, that is, the cards 502 are the first to be stacked up among the respective sheet groups 500). Consequently, the card 502 of the sheet group 500B is disposed between the banknotes 501 of the sheet group 500B and the sheet group 500A. That is, the card 502 of the sheet group 500B functions as a separator that partitions between the bundle of the banknotes 501 of the sheet group 500B and the bundle of the banknotes 501 of the sheet group 500A.

Since each of the cards 502 is placed at the bottom of the sheet group 500 to which the card 502 belongs, the card 502 of the upper sheet group 500B is located at the boundary between the upper sheet group 500B and the lower sheet group 500A in the example illustrated in FIG. 2. That is, each of the cards 502 serves to identify its sheet group 500, and also functions as a separator that physically partitions between the sheet group 500A and the sheet group 500B when a plurality of sheet groups 500A and 500B are stored in the banknote storage bag 17 as illustrated in FIG. 2.

In addition, on the basis of the recognition information of the recognition unit 11, the control unit 50 calculates the total money amount of the banknotes 501 transported to the banknote storage bags 17 for each of the sheet groups 500A and 500B in the example illustrated in FIG. 2. Then, the control unit 50 controls the transmission unit 51 such that the information set Info.1 for each of the sheet groups 500 in which the total money amount is associated with the serial number of the card 502 stored in the banknote storage bag 17 is transmitted to the banknote processing server 3. That is, the information set Info. (first sheet group information) on the sheet group 500A and the information set Info.1 (second sheet group information) on the sheet group 500B are transmitted to the banknote processing server 3.

In addition, the control unit 50 controls the heating members 18b and the holding-member driving unit 18c such that the opening 17a of the banknote storage bag 17 is sealed when the control unit 50 receives operation from the operation displaying unit 12 to instruct the control unit 50 to seal the banknote storage bag 17.

In addition, the control unit 50 performs predetermined processing for collecting the banknote storage bags 17 on condition that there is any card 502 stored in the banknote storage bags 17. Here, the control unit 50 determines that a card 502 is stored in the banknote storage bags 17 when the serial number of the card 502 recognized by the recognition unit 11 is stored in the memory unit 52. Meanwhile, the control unit 50 determines that no card 502 is stored in the banknote storage bags 17 when no serial number of any card 502 is stored in the memory unit 52.

The predetermined processing for collecting the banknote storage bags 17 includes processing to appropriately control the holding-member driving units 18c and the heating members 18b such that the openings 17a of the banknote storage bags 17 are heat sealed. In the present embodiment, when no card 502 is stored in the banknote storage bags 17, the control unit 50 is prohibited from heat sealing the openings 17a of the banknote storage bags 17 and consequently from collecting the banknote storage bags 17. Note that, the control device 50 may also be prohibited from performing other processing for collecting the banknote storage bags 17, for example, from unlocking the door 10c.

In addition, the control unit 50 obtains, based on the detection result of the recognition unit 11, the number of sheets N1 (first number of sheets) of the sheets 501 and 502 being stored in the storing/feeding unit 16 and the number of sheets N2 (second number of sheets) of the sheets 501 and 502 being stored in the banknote storage bags 17, so as to obtain a total value N of these numbers of sheets (N=N+N2). The control unit 50 permits the sheets 501 and 502 in the storing/feeding unit 16 to be stored in the storing/feeding unit 16 when this total value N is equal to or less than the maximum number of sheets Nmax of the sheets 501 and 502 that can be stored in the banknote storage bags 17 (N≤Nmax).

Note that, in a case where this total value N exceeds the maximum number of sheets Nmax of the sheets 501 and 502 that can be stored in the banknote storage bags 17 (N>Nmax), the control unit 50 may start to seal the banknote storage bags 17 even when no operation from the operation displaying unit 12 to instruct the control unit 50 to seal the banknote storage bags 17 is received.

[2-2. Control Flow]

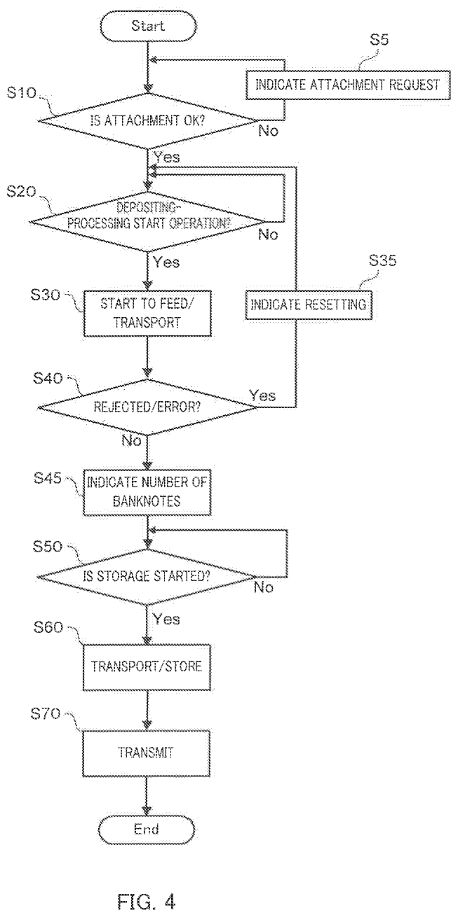

A description will be given of banknote processing according to Embodiment 1 of the present invention with reference to FIG. 4. FIG. 4 is a flowchart illustrating an exemplary control flow of the banknote processing according to Embodiment 1 of the present invention. Note that, this control flow is repeatedly carried out every time one sheet group 500 is processed.

At step S10, the control unit 50 determines, based on detection results of the attachment detection units 18d, whether or not the banknote storage bags 17 are attached to the holding members 18a.

When the control unit 50 determines that the banknote storage bags 17 are not attached to the holding members 18a, the control unit 50 causes the operation displaying unit 12 to display an indication requesting attachment of the banknote storage bags 17 at step S5. Then, the control unit 50 determines again at step S10 whether or not the banknote storage bags 17 are attached to the holding members 18a.

When the control unit 50 determines at step S10 that the banknote storage bags 17 are attached to the holding members 18a, the control unit 50 determines at step S20 whether or not the operation displaying unit 12 has received the operation to start the depositing processing. When the control unit 50 determines that no operation to start the depositing processing has been received, the control unit 50 determines again at step S20 whether or not the operation to start the depositing processing has been received. On the other hand, when the control unit 50 determines at step S20 that the operation to start the depositing processing has been received, the control unit 50 actuates the banknote feeding mechanism 13a and the transport unit 15 such that the banknote feeding mechanism 13a and the transport unit 15 start to transport the sheets 501 and 502 at step S30. On this occasion, the control unit 50 receives various pieces of information obtained by the recognition unit 11 from the sheets 501 and 502 under conveyance, and causes the memory unit 52 to store the information therein.

At step S40, the control unit 50 determines, based on the recognition information stored in the memory unit 52, whether or not there is any rejected sheet or whether or not an error such as poor recognition by the recognition unit 11 has arisen. When the control unit 50 determines that there is a rejected sheet or an error has arisen, the control unit 50 causes, at step S35, the operation displaying unit 12 to display an indication for recommending resetting the rejected sheet in the inlet unit 13. Subsequently, the control unit 50 determines again at step S20 whether or not the operation to start the depositing processing has been received.

Meanwhile, at step S40, when the control unit 50 determines that there is no rejected sheet or no error has arisen, the control unit 50 causes, at step S45, the operation displaying unit 12 to display the total number of sheets (counting result) of the banknotes 501 belonging to the sheet group 500 stored in the storing/feeding unit 16 based on the detection result of the recognition unit 11. The control unit 50 also causes the operation displaying unit 12 to display, together with the indication of the total number of sheets of the banknotes 501, an indication for inquiring whether or not to start to store the sheet group 500 in the banknote storage bags 17.

The control unit 50 determines at step S50 whether or not the operation displaying unit 12 has received operation to start to store the sheet group 500 in the banknote storage bags 17 (such operation is hereinafter referred to as “storage start operation”). For example, a depositor performs the storage start operation when the number of deposited sheets of the banknotes as recognized by the depositor and the total number of sheets of the banknotes 501 displayed on the operation displaying unit 12 are the same, and otherwise the depositor performs operation to cancel the depositing processing with the operation displaying unit 12.

When the operation displaying unit 12 has not received any storage start operation, the control unit 50 determines again at step S50 whether or not the operation displaying unit 12 has received the storage start operation.

Meanwhile, when the control unit 50 determines at step S50 that the storage start operation has been received, the control unit 50 controls, at step S60, the storing/feeding unit 16 and the transport unit 15 such that the sheet group 500 in the storing/feeding unit 16 is transported and stored in the banknote storage bags 17, with the card 502 being transported first among the sheet group 500.

Then, at step S70, the control unit 50 transmits, to the banknote processing server 3, the information set Info.1 in which the total money amount of the banknotes 501 and the like are associated with the serial number of the card 502 for each sheet group 500.

Note that, while the above descriptions have been given in which the control unit 50 is configured to perform processing such that the banknotes 501 and the cards 502 are transported via the storing/feeding unit 16 (once stored in the storing/feeding unit 16) and subsequently stored in the banknote storage bags 17, the control unit 50 may also be configured to perform processing such that the banknotes 501 and the cards 502 are stored in the banknote storage bags 17 without transported via the storing/feeding unit 16. In this case, the sheets 501 and 502 are stacked up in the banknote storage bags 17 in the order in which the sheets 501 and 502 are stacked up in the inlet unit 13. For example, in a case where the sheets 501 and 502 belonging to the same sheet group 500 are stacked up in the banknote storage bags 17 in the order as illustrated in FIG. 2, the sheets are set in the inlet unit 13 with the sheet 502 (card 502) being disposed under the sheets 501 (banknotes 501).

[2-3. Effect]

(1) According to Embodiment 1 of the present invention, the control unit 50 controls the transport unit 15 based on the recognition result by the recognition unit 11 in the banknote processing apparatus 1A, so that the card 502 having the serial number for identifying the sheet group 500 is stored together with the banknotes 501 in the banknote storage bag 17. Specifically, in the banknote processing apparatus 1A, the banknotes 501 (sheets 501) and the card 502 (sheet 502) which is not a banknote and which functions as the separator are put in the banknote processing apparatus 1A from the inlet unit 13, and are stored in the banknote storage bag 17. Accordingly, the work for subsequently attaching the card 502 to the sheet group 500 becomes unnecessary. That is, it is possible to omit the advance preparation for processing the sheets using the card 502 at the cash collection center C.

(2) Moreover, since the card 502 functions as the separator for physically partitioning between a plurality of sheet groups 500A and 500B, it is possible to process the sheet groups 500A and 500B not separately but continuously when the sheet groups 500A and 500B are processed by the banknote processing apparatus 2 in the cash collection center C.

(3) Furthermore, since sealing of the opening 17a of the banknote storage bag 17 is performed after the card 502 is stored in the banknote storage bag 17, sealing the opening 17a without any card 502 being stored is prohibited. Consequently, detachment of the banknote storage bag 17 from the banknote processing apparatus 1, which is to be performed after the opening 17a is sealed, is prohibited. Therefore, it is ensured that the card 502 can be conveyed together with the banknotes 501 to the cash collection center C in which the banknote processing apparatus 2 is installed.

(4), When the total value N of the number of sheets N1 of the sheets 501 and 502 in the storing/feeding unit 16 and the number of sheets N2 of the sheets 501 and 502 already stored in the banknote storage bags 17 is equal to or less than the maximum number of sheets Nmax that can be stored in the banknote storage bags 17, it is permitted to store, in the storing/feeding unit 16, the sheets 501 and 502 being stored in the banknote storage bags 17. Therefore, it is possible to efficiently store as many sheet groups 500 as possible in the banknote storage bags 17.

(5) The recognition unit 11 reads the serial number of the card 502. Therefore, it becomes possible to produce the information set Info.1 in which the serial number is associated with the sales proceeds amount of the banknotes 501 belonging to the same sheet group 500 as the card 502. The serial number of the card 502 is associated with the sales proceeds amount also in the information set Info.2 obtained by the banknote processing apparatus 2 in the cash collection center C. By comparing the sales proceeds amounts in the information set Info.1 with the sales proceeds amounts in the information set Info.2 sharing the common serial number with the information set Info.1, it is possible to verify whether the sales proceeds amounts in the information sets Info.1 and Info.2 which are the information sets related to the same transaction are the same as each other. In addition, such verification can be performed efficiently by outputting, to the banknote processing server 3, the information set Info.1 from the banknote processing apparatus 1A and the information set Info.2 from the banknote processing apparatus 2 and by comparison between these information sets Info.1 and Info.2 by the banknote processing server 3.

(6) The card 502 that partitions between a plurality of sheet groups 500A and 500B is not a banknote, so that the sheet groups 500A and 500B can be partitioned distinctly, and it is possible to reduce erroneous recognition of the boundary between the sheet groups 500A and 500B.

(7) The card 502 is supplied to the transport unit 15 from the inlet unit 13 provided in the outside of the banknote processing apparatus 1A, so that the card 502 can be set in the inlet unit 13 manually. It is therefore possible to simplify the configuration of the banknote processing apparatus 1A. Moreover, the inlet unit 13 through which the banknotes 501 are put in is also used for supplying the card 502, which also makes it possible to simplify the configuration of the banknote processing apparatus 1A.

(8) The apparatus information or the serial number of the card 502 is associated with the information set Info.1, and is sent to the banknote processing server 3. The banknote processing server 3 outputs the user information obtained from the apparatus information or the card 502 to the outside (to the banknote processing apparatus 2 in the cash collection center C in the present embodiment). It is therefore possible to clarify an owner of the sheet group 500 including the card 502 with the serial number.

(9) Since the information set Info.1 includes the store information and the date information, so that it is possible to delicately manage the sales proceeds amount.

(10) Inclusion of the operator information in the information set Info.1 makes it possible to clarify where the responsibility for the depositing processing lies.

[2-4. Variations]

(1) Although the banknotes 501 and the card 502 belonging to the same sheet group 500 are stacked up together in the inlet unit 13 in the embodiment described above, so that the banknotes 501 and the card 502 are continuously processed, the present invention is not limited to this embodiment. The card 502 may be set in the inlet unit 13 and transported to the storing/feeding unit 16 after all the banknotes 501 belonging to the same sheet group 500 are transported to the storing/feeding unit 16. Alternatively, the banknotes 501 may also be set in the inlet unit 13 and transported to the storing/feeding unit 16 after the card 502 is transported to the storing/feeding unit 16.

(2) Although the above embodiment has been described in relation to an example in which a plurality of sheet groups 500 are stored in the banknote storage bags 17, collected, and then transported to the cash collection center C, only a single sheet group 500 may be stored in the banknote storage bags 17, collected, and then transported to the cash collection center C.

(3) Storing the card 502 in the banknote storage bag 17 may trigger sealing of the banknote storage bag 17. For example, a configuration is employed in which it is decided in advance to store only a single sheet group 500 in the banknote storage bag 17 and to collect it, and the card 502 in the sheet group 500 is stored lastly in the banknote storage bag 17. In this configuration, the banknote storage bag 17 is sealed after the card 502 is stored in the banknote storage bag 17.

(4) Processing performed before detachment of the banknote storage bag 17 from the banknote processing apparatus 1A may include processing of partitioning the banknote storage bag 17 between the banknotes 501 and the card 502. For example, the left side surface and the right side surface of the banknote storage bag 17 may be welded at above the card 502 continuously or discontinuously in the front-rear direction after the card 502 is stored and before the banknotes 501 are stored.

Such welding only needs to make it possible to partition between the banknotes 501 and the card 502 such that the banknotes 501 do not move to the side of the card 502 and the card 502 not to the side of the banknotes 501, and the welding line of such welding may, for example, be in the form of a broken line. Accordingly, in the case where the banknote storage bag 17 is partitioned between the banknotes 501 and the card 502, a banknote storage bag 17 of a free-fall type may also be used instead of the banknote storage bag 17 of the stacking type. That is, while the banknotes 501 and the card 502 stored in the banknote storage bag 17 are mixed usually in the case of the banknote storage bag 17 of the free-fall type, it is possible to prevent such mixture and to find out the card 502 easily by partitioning between the banknotes 501 and the card 502.

In this case, a mechanism for welding the banknote storage bag 17 at a predetermined height of the banknote storage bag 17 is needed. Such a mechanism may include one that can move a welding apparatus that sandwiches and welds the banknote storage bag 17 up and down.

In addition, when a plurality of sheet groups 500 are stored in the banknote storage bag 17, the banknote storage bag 17 may be partitioned between one sheet group 500 and another with a similar technique.

For example, partitioning the banknote storage bag 17 between the banknotes 501 and the card 502 makes it possible to prevent the card 502 from being mixed in the banknotes 501 even when the stacked state of the sheet group 500 collapses within the banknote storage bag 17 during when the banknote storage bag 17 is transferred to the cash collection center C from the commercial establishment A. Moreover, partitioning the banknote storage bag 17 between one sheet group 500 and another makes it possible to prevent different sheet groups 500 from being mixed even when the stacked state of the sheet groups 500 collapse within the banknote storage bag 17.

(5) The card 502 may also be disposed on the top of the sheet group 500 (at the uppermost position, that is, the order in which the card 502 is stacked is the last among the sheet group 500) in the banknote storage bag 17. Alternatively, cards 502 may also be disposed respectively at both of the top and the bottom of one sheet group 500.

### 3. Embodiment 2

[3-1. Configuration]

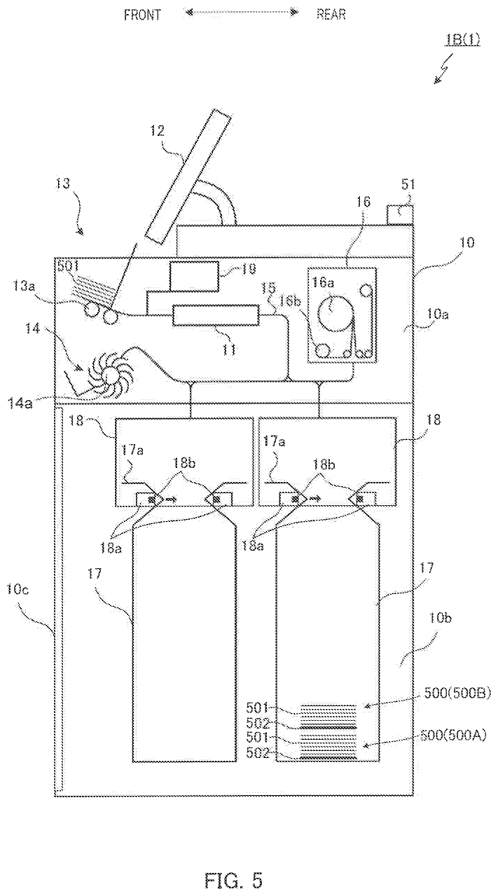

A description will be given of a banknote processing apparatus of Embodiment 2 of the present invention with reference to FIG. 5. FIG. 5 schematically illustrates a configuration of the banknote processing apparatus of Embodiment 2 of the present invention.

The banknote processing apparatus 1 of the present embodiment is comprised of a banknote processing apparatus 1B (first processing apparatus) illustrated in FIG. 5. This banknote processing apparatus 1B is different from the banknote processing apparatus 1A of Embodiment 1 (see FIG. 2) in that the banknote processing apparatus 1B is provided with a card supplying unit 19 (supplying unit).

The card supplying unit 19 can hold a plurality of cards 502, and feeds these cards 502 to the transport unit 15 one by one. This card supplying unit 19 is comprised of a feeding apparatus of a tape-reel type like the storing/feeding unit 16 in the present embodiment. The card supplying unit 19 is configured to supply the cards 502 at a position on the transport path 15 more upstream than the recognition unit 11.

The sheet processing apparatus 1B is provided with the control unit 50 (see FIG. 1). When the control unit 50 detects that the operation displaying unit 12 has received the operation to start the depositing processing, the control unit 50 controls the card supplying unit 19 such that the card supplying unit 19 at a position in front of the recognition unit 11 (on the upstream side of the recognition unit 11 in the transportation direction) supplies one of the cards 502 to the transport unit 15. The control unit 50 controls the transport unit 15 such that this card 502 is transported to the storing/feeding unit 16. Subsequently, the control unit 50 controls the banknote feeding mechanism 13a and the transport unit 15 such that the banknotes 501 are sent out one after another from the inlet unit 13 and are transported to the storing/feeding unit 16 by the transport unit 15.

Note that, the card 502 may be supplied to the storing/feeding unit 16 after all the banknotes 501 in the inlet unit 13 are transported to the storing/feeding unit 16. For example, after the last one of the banknotes 501 in the inlet unit 13 is transported to the storing/feeding unit 16, the control unit 50 controls the card supplying unit 19 such that the card 502 is supplied to the transport unit 15.

In addition, the card supplying unit 19 is provided with a sensor (not illustrated) that monitors the number of sheets of the cards 502 held. A detection result of this sensor is transmitted to the control unit 50. The control unit 50 causes the operation displaying unit 12 to display a message for recommending to replenish the card supplying unit 19 with cards 502, when the control unit 50 determines, based on this detection result, that the number of sheets of the cards 502 held by the card supplying unit 19 is equal to or less than a predetermined number of sheets.

[3-2. Control Flow]

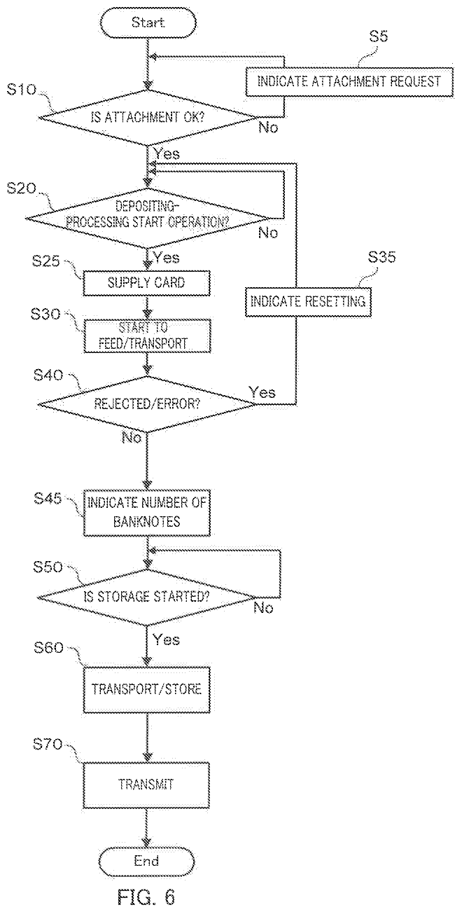

A description will be given of banknote processing according to Embodiment 2 of the present invention with reference to FIG. 6. FIG. 6 is a flowchart illustrating an exemplary control flow of the banknote processing according to Embodiment 2 of the present invention. Note that, this control flow is repeatedly carried out every time one sheet group 500 is processed.

The control flow illustrated in FIG. 6 is different from the control flow according to Embodiment 1 illustrated in FIG. 4 in that step S25 is added. That is, when the operation displaying unit 12 receives the storage start operation and the depositing processing is started, the control unit 50 actuates the card supplying unit 19 at step S25 such that a card 502 is supplied to the storing/feeding unit 16, and then controls the transport unit 15 such that the card 502 is transported to and stored in the banknote storage bag 17. Subsequently, the control unit 50 controls the storing/feeding unit 16 and the transport unit 15 at step S30 such that the banknotes 501 are transported to and stored in the banknote storage bag 17.

Note that, when the processing goes back to step S25 via step S20 because there is a rejected sheet or an error such as poor recognition by the recognition unit 11 has arisen at step S40, the control unit 50 does not actuate the card supplying unit 19 since the card 502 is already supplied.

Note that, the step of actuating the card supplying unit 19 may be provided between step S60 and step S70 instead of between step S20 and step S30. In this case, the card 502 is stored in the storing/feeding unit 16 after all the banknotes 501 are stored in the storing/feeding unit 16.

Since the present control flow is identical to the control flow of the banknote processing apparatus 1A of Embodiment 1 except for the above difference, descriptions of the other steps are omitted.

[3-3. Effect]

In addition to the effects of Embodiment 1, the card 502 is supplied by the card supplying unit 19 according to Embodiment 2 of the present invention. Specifically, the banknotes 501 (sheets 501) are put in the banknote processing apparatus 1B through the inlet unit 13, and then, the card 502 (sheet 502) that is not a banknote and functions as the separator is supplied from the card supplying unit 19 in the banknote processing apparatus 1B. Then, the banknotes 501 and the card 502 are stored in the banknote storage bag 17. It is thus possible to omit the work that an operator puts the card 502 on the banknotes 501 in the banknote processing apparatus 1.

[3-4. Variation]

(1) Supplying the card 502 from the card supplying unit 19 and then storing the card 502 in the banknote storage bag 17 after receipt of the storage start operation by the operation displaying unit 12 may trigger sealing of the banknote storage bag 17.

### 4. Embodiment 3

[4-1. Configuration]

[4-1-1. Configuration of Banknote Processing Apparatus]

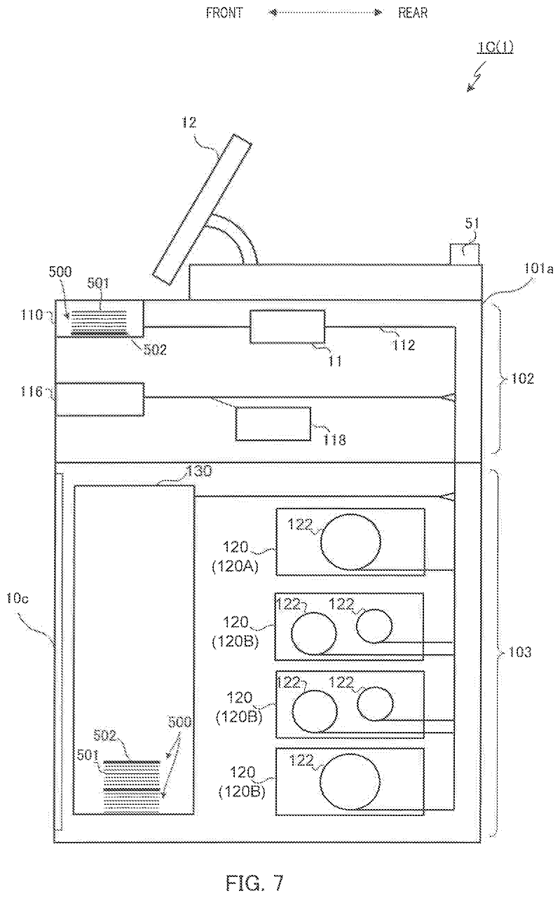

A description will be given of a banknote processing apparatus of Embodiment 3 of the present invention with reference to FIG. 7. FIG. 7 schematically illustrates a configuration of the banknote processing apparatus of Embodiment 3 of the present invention.

The banknote processing apparatus 1 of the present embodiment is comprised of a banknote processing apparatus 1C (first processing apparatus) illustrated in FIG. 7. This banknote processing apparatus 1C is configured to be able to perform various processes such as the banknote depositing process like the banknote processing apparatus 1A of Embodiment 1. In the following description, the side of the banknote processing apparatus 1C on which the operation displaying unit 12 is disposed is referred to as “front side,” the opposite side is referred to as “rear side,” and the horizontal direction that is orthogonal to the front-rear direction is referred to as “left-right direction.”

As illustrated in FIG. 7, the banknote processing apparatus 1C comprises a housing 101a having a substantially rectangular parallelepiped shape. The banknote processing apparatus 1C also comprises an upper unit 102 and a lower unit 103. The upper unit 102 is provided with an inlet unit 110, a transport unit 112, a recognition unit 11, a banknote outlet unit 116, and a dispensing rejection unit 118.

The inlet unit 110 is for putting a plurality of banknotes 501 and cards 502 constituting sheet groups 500 inside the housing 101a from the outside of the housing 101a.

The transport unit 112 transports the sheets 501 and 502 which have been put in the housing 101a through the inlet unit 110.

Like in Embodiment 1, the recognition unit 11 recognizes the denomination, authenticity, faceback, fitness, new/old, transport state, and the like of each of the banknotes 501 transported by the transport unit 15, and the recognition unit 11 further recognizes the authenticity and the serial number of each of the cards 502 transported by the transport unit 15.

The banknote outlet unit 116 puts the banknotes 501 outside the housing 101a from the inside of the housing 101a.

The dispensing rejection unit 118 stores therein the rejected sheets.

One sheet group 500 is placed in the inlet unit 110 by an operator. The inlet unit 110 is provided with a plurality of rollers, such as feed rollers and kicker rollers, and the sheets 501 and 502 constituting the sheet group 500 are flicked out by a kicker roller toward a feed roller one by one in the order from the bottom sheet. These flicked-out banknotes are fed by the feed roller one by one to the inside of the housing 101a. The sheets 501 and 502 fed to the inside of the housing 101a are transported one by one by the transport unit 112.

In addition, the transport unit 112 is provided to extend over the upper unit 102 and the lower unit 103 as illustrated in FIG. 7. A plurality of storing/feeding units 120 (temporary storage units) are connected to the transport unit 112 in the lower unit 103 (four storing/feeding units 120 in the example illustrated in FIG. 7).

Each of the storing/feeding units 120 can store the banknotes 501 or the cards 502 sent by the transport unit 112 and can feed the banknotes 501 or the cards 502 to the transport unit 112 one by one. Specifically, each of the storing/feeding units 120 includes one or more drums 122, and, each one of the banknotes 501 or the cards 502 sent by the transport unit 112 is sandwiched between a pair of tapes and the tapes together with the banknotes inserted between the tapes are wound around each of the drums 122. In addition, when the drum 122 rotates in the direction reverse to the direction in which the tapes are wound around the drum 122, the tapes are unwound from the drum 122, so that the banknotes 501 or the cards 502 inserted between the pair of tapes are fed one by one to the transport unit 112.

In addition, the lower unit 103 is provided with a storage cassette 130 (storage unit) that stores therein the sheet groups 500 transported by the transport unit 112. This storage cassette 130 is detachably set in a cassette attaching unit, which is not illustrated. It is possible to collect the sheet groups 500 together with the storage cassette 130 by detaching the storage cassette 130 from the cassette attaching unit and opening a door 10c provided on the front surface of the lower unit 103 to take the storage cassette 130 out of the housing 101a. The sheet groups 500 are transferred together with the storage cassette 130 to the cash collection center C.

[4-1-2. Control]

The sheet processing apparatus 1C is provided with the control unit 50 (see FIG. 1). When the control unit 50 detects receipt of operation by the operation displaying unit 12 to start the depositing processing, the control unit 50 feeds the sheets 501 and 502 which are placed in the inlet unit 110 and constitute a sheet group 502 to the transport unit 112 one by one in the order from the bottom sheet.

The control unit 50 controls the transport unit 112 such that a sheet recognized by the recognition unit 11 as a card (card 502) is transported to a card storing/feeding unit 120A that is one of the storing/feeding units 120 which is configured in advance for storage of the card 502. Note that, the topmost storing/feeding unit 120 is used as the card storing/feeding unit 120A in the present embodiment.

The control unit 50 also controls the transport unit 112 such that sheets (banknotes 501) recognized by the recognition unit 11 as a fit note are transported to predetermined banknote storing/feeding units 120B according to the denominations. The banknote storing/feeding units 120B are those of the storing/feeding units 120 other than the card storing/feeding unit 120A.

After all the sheets 501 and 502 constituting the sheet group 500 are transported to the storing/feeding units 120, the control unit 50 performs the following control when the control unit 50 detects that the operation displaying unit 12 has received the storage start operation.

That is, the control unit 50 feeds the banknotes 501 stored in the banknote storing/feeding units 120B and the card 502 stored in the card storing/feeding unit 120A to store them in the storage cassette 130. Specifically, the control unit 50 sends the banknotes 501 to the storage cassette 130 from the banknote storing/feeding units 120B after sending one card 502 to the storage cassette 130 from the card storing/feeding unit 120A. Alternatively, the control unit 50 sends the card 502 to the storage cassette 130 from the card storing/feeding unit 120A after sending the banknotes 501 to the storage cassette 130 from all the banknote storing/feeding units 120B. This makes it possible for the card 502 to be placed at the bottom or at the top of the sheet group 500.

When the sheet groups 500 are stored in the storage cassette 130, or when the operation displaying unit 12 receives the storage start operation, the control unit 50 calculates the total money amount of the sheet group 500 based on the denominations of the banknotes 501 and the number of sheets for each denomination of the banknotes 501 of the sheet group 500 contained in the memory unit 52. Then, the control unit 50 controls the transmission unit 51 such that this total money amount and the information set Info.1 including the serial number of the card 502 that belongs to the same sheet group 500 as the banknotes 501 and the like are transmitted to the banknote processing server 3.

The predetermined processing for collecting the storage cassette 130 from the banknote processing apparatus 1C includes unlocking to open the door 10c locked by the door locking unit. When no card 502 is stored in the storage cassette 130, the control unit 50 prohibits unlocking of the door 10c so as to prohibit collecting the storage cassette 130.

Since other configurations than described above are the same as those of Embodiment 1, descriptions of such other configurations will be omitted.

[4-2. Effect]

According to Embodiment 3 of the present invention, it is possible to obtain the same effects as Embodiment 1.

### 5. Embodiment 4

[5-1. Configuration]

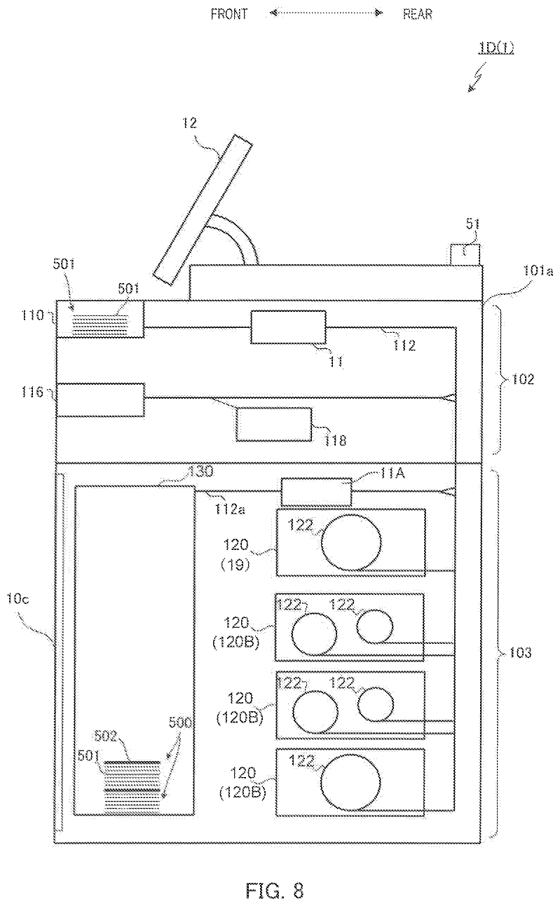

A description will be given of a banknote processing apparatus of Embodiment 4 of the present invention with reference to FIG. 8. FIG. 8 schematically illustrates a configuration of the banknote processing apparatus of Embodiment 4 of the present invention.

The banknote processing apparatus 1 of the present embodiment is comprised of a banknote processing apparatus 1D (first processing apparatus) illustrated in FIG. 8. This banknote processing apparatus 1D is different from the banknote processing apparatus 1C of Embodiment 3 (see FIG. 7) in the following points. That is, a predetermined storing/feeding unit 120 (the topmost storing/feeding unit 120 in the present embodiment) among a plurality of storing/feeding units 120 is used as a card supplying unit 19 in the banknote processing apparatus 1D. Moreover, the banknote processing apparatus 1D is provided with a recognition unit 11A at a part 112a of the transport unit 112 (which is referred hereinafter to as “transport unit 112a”) extending to the storage cassette 130. The recognition unit 11A recognizes the authenticity and the serial number of the card 502 supplied from the card supplying unit 19 to the transport unit 112a.

The sheet processing apparatus 1D is provided with the control unit 50 (see FIG. 1). When the control unit 50 detects that the operation displaying unit 12 has received the storage start operation, the control unit 50 controls the banknote storing/feeding units 120B and the transport unit 112a such that the banknotes 501 in the banknote storing/feeding units 120B are stored in the storage cassette 130. When all the banknotes 501 belonging to a sheet group 500 are stored in the storage cassette 130, the control unit 50 controls the card supplying unit 19 such that one card 502 is supplied to the transport unit 112a, and also controls the transport unit 112a such that this card 502 is transported to the storage cassette 130.

Note that, the banknotes 501 may be stored in the storage cassette 130 after the card 502 is stored in the storage cassette 130.

[5-2. Effect]

According to Embodiment 4 of the present invention, it is possible to obtain the same effects as Embodiment 3.

### 6. Variations

(1) Although the sheet group 50X) is identified with the card 502 that is not a banknote and functions as a separator in Embodiment 1 or Embodiment 3, the sheet group 500 may also be identifiable with a banknote 501 included in the sheet group 500 without the card 502 functioning as the separator. Specifically, a serial number, which is identified by the recognition unit 11, of the banknote 501 that functions as the separator (such a banknote 501 is hereinafter referred to as “specific banknote 501”) is used as the identification information for identifying the sheet group 500. The specific banknote 501 is at least the topmost one or bottommost one of a plurality of banknotes 501 constituting the sheet group 500.

In other words, in this variation, the banknotes 501 (sheets 501) including the specific banknote 501 (sheet 501) that functions as the separator in the banknote processing apparatus 1 are put in the banknote processing apparatus 1 through the inlet unit 13, the serial number of the specific banknote 501 (specific sheet 501) of the banknotes 501 which have been put in the banknote processing apparatus 1 is obtained as the identification information, and the banknotes 501 including the specific banknote 501 are then stored in the banknote storage bag 17.

Using the serial number of a banknote 501 as the identification information for identifying the sheet group 500 makes it possible to dispense with the card 502.

(2) Although the card 502 is supplied to the transport unit 15 from the inlet unit 13 that is for inlet of the banknotes 501 and that is provided in the outside of the banknote processing apparatus 1A in Embodiment 1 or Embodiment 3, an inlet unit solely for supplying the card 502 to the transport unit 15 may be provided in addition to the inlet unit 13.

(3) The serial number of the card 502 may be associated with storage-unit identification information given to the banknote storage bag 17 or the storage cassette 130 for identifying the banknote storage bag 17 or the storage cassette 130 (e.g., a specific number for each banknote storage bag 17 or a specific number for each storage cassette 130). That is, the information set Info.1 may also include the storage-unit identification information on the banknote storage bag 17 or the storage cassette 130.

(4) The card 502 may also be supplied not only from the card supplying unit 19 but also from the inlet unit 13 in Embodiment 2. Likewise, the card 502 may also be supplied not only from the card supplying unit 19 (storing/feeding unit 120) but also from the inlet unit 110 in Embodiment 4.

(5) Although the above embodiments have been described in relation to an example in which the banknote storage bag 17 or the storage cassette 130 stores a plurality of sheet groups 500, the banknote storage bag 17 or the storage cassette 130 may store a single sheet group 500.

### INDUSTRIAL APPLICABILITY

The present invention is applicable to a sheet processing apparatus that processes a sheet group consisting of a plurality of sheets. Accordingly, the present invention is greatly industrially applicable.

### REFERENCE SIGNS LIST

1, 1A, 1B, 1C, 1D Banknote processing apparatus (first processing apparatus)
2 Banknote processing apparatus (second processing apparatus)
3 Banknote processing server (sheet processing server)
10 Housing
10a Upper unit
10b Lower unit
10c Door
11, 11A Recognition unit
12 Operation displaying unit
13 Inlet unit
13a Banknote feeding mechanism
14 Outlet unit
14a Stacking wheel
15 Transport unit
16 Storing/feeding unit (temporary storage unit)
16a Drum
17 Banknote storage bag (storage unit)
18 Banknote storage mechanism
18a Holding member
18b Heating member
19 Card supplying unit (Supplying unit)
50 Control unit
51 Transmission unit
52 Storage unit
60 Control unit
61 Transmission and reception unit
70 Server control unit
71 Transmission and reception unit
72 Storage unit
101a Housing
102 Upper unit
103 Lower unit
110 Inlet unit
112, 112a Transport unit
116 Banknote outlet unit
118 Dispensing rejection unit
120 Storing/feeding unit (temporary storage unit)
120A Card storing/feeding unit
120B Banknote storing/feeding unit
130 Storage cassette (storage unit)
500 Sheet group
500A Sheet group (second sheet group)
500B Sheet group (first sheet group)
501 Banknote (first sheet)
502 Card (second sheet)
Info.1 Information set of banknote processing apparatus 1
Info.2 Information set of banknote processing apparatus 2
A Commercial establishment
C Cash collection center
S Sheet processing system

1. A sheet processing apparatus, comprising:
a recognition unit that recognizes a kind of a sheet;
a transport unit that transports the sheet recognized by the recognition unit;
a storage unit that stores therein a sheet group consisting of a plurality of the sheets transported by the transport unit; and
a control unit, wherein:
the plurality of sheets include a first sheet to which value is given, and a second sheet to which identification information for identifying the sheet group is given in advance, and
the control unit controls the transport unit based on a recognition result by the recognition unit such that the transport unit transports at least one of the plurality of sheets recognized as the first sheet to be received by the storage unit and at least one of the plurality of sheets recognized as the second sheet into the storage unit.

2. The sheet processing apparatus according to claim 1, wherein
the control unit performs predetermined processing on the storage unit at least after the second sheet is stored in the storage unit, and
the storage unit is configured to be detachable from the sheet processing apparatus after the predetermined processing is performed by the control unit.

3. The sheet processing apparatus according to claim 2, wherein
the storage unit has an opening through which the sheet transported by the transport unit is put in the storage unit, and
the predetermined processing performed by the control unit includes processing of sealing the opening.

4. The sheet processing apparatus according to claim 3, wherein
the predetermined processing includes processing of partitioning between the first sheet and the second sheet.

5. The sheet processing apparatus according to claim 1, wherein
the control unit controls the transport unit such that the second sheet is disposed at least at an uppermost position or a lowermost position of the sheet group in the storage unit.

6. The sheet processing apparatus according to claim 1, further comprising:
a supplying unit that holds a plurality of the second sheets and supplies the plurality of second sheets one by one to the transport unit.

7. The sheet processing apparatus according to claim 1, further comprising:
an inlet unit through which the second sheet is supplied from an outside of the sheet processing apparatus to the transport unit.

8. The sheet processing apparatus according to claim 1, wherein
the control unit outputs, to the outside, an information set in which sheet group information on the sheet group stored in the storage unit is associated with the identification information for identifying the sheet group.

9. The sheet processing apparatus according to claim 8, wherein
the information set includes apparatus information on the sheet processing apparatus.

10. A sheet processing server, comprising:
an input unit in which the information set output from a first processing apparatus being the sheet processing apparatus according to claim 8 is input; and
a server control unit that associates the information set with user information on a user of the first processing apparatus.

11. The sheet processing server according to claim 10, further comprising:
a memory unit that stores therein correspondence between the identification information of the second sheet and the user information in advance, wherein
the server control unit associates the information set with the user information obtained from the correspondence according to the identification information.

12. The sheet processing server according to claim 10, wherein
the information set includes apparatus information on the first processing apparatus,
the sheet processing server further comprises a memory unit that stores therein correspondence between the apparatus information and the user information in advance, and
the server control unit associates the information set with the user information obtained from the correspondence according to the apparatus information.

13. A sheet processing system, comprising:
a first processing apparatus that is the sheet processing apparatus according to claim 8;
a sheet processing server; and
a second processing apparatus, wherein
the sheet processing server, comprising:
an input unit in which the information set output from the first processing apparatus is input;
a server control unit that associates the information set with user information on a user of the first processing apparatus, and
the sheet group information on the sheet group at least includes money amount information of the sheet group,
the second processing apparatus obtains the money amount information and the identification information by processing the sheet group processed by the first processing apparatus, and
the server control unit of the sheet processing server or a control unit of the second processing apparatus compares the identification information obtained by the first processing apparatus with the identification information obtained by the second processing apparatus and compares the sheet group information obtained by the first processing apparatus with the sheet group information obtained by the second processing apparatus.
